(19) United States
(12) Patent Application Publication
(10) Pub. No.: US 2025/0085667 A1
(43) Pub. Date: Mar. 13, 2025

(54) CASE, TIMEPIECE AND CASE MANUFACTURING METHOD

(71) Applicant: CASIO COMPUTER CO., LTD., Shibuya-ku (JP)

(72) Inventor: Takumi YASUDA, Tokyo (JP)

(73) Assignee: CASIO COMPUTER CO., LTD., Shibuya-ku (JP)

(21) Appl. No.: 18/828,185

(22) Filed: Sep. 9, 2024

(30) Foreign Application Priority Data
Sep. 11, 2023 (JP) 2023-146879

(51) Int. Cl. G04B 37/22; G04B 37/08

(52) U.S. Cl. CPC G04B 37/22; G04B 37/08

(57) ABSTRACT

A case including a case main body, a first exterior part which is arranged on an outer circumferential surface of the case main body, a second exterior part which is arranged on the outer circumferential surface of the case main body and an outer circumferential surface of the first exterior part, and an attachment part which attaches the second exterior part to the case main body, and attaches the first exterior part to the case main body by holding the first exterior part by the second exterior part.

### CROSS-REFERENCE TO RELATED APPLICATION

This application is based upon and claims the benefit of priority from the prior Japanese Patent Application No. 2023-146879, filed Sep. 11, 2023, the entire contents of which are incorporated herein by reference.

### BACKGROUND

### 1. Technical Field

The present disclosure relates to a case that is used for electronic devices such as wristwatches, a timepiece equipped with the cover, and a method for manufacturing the case.

### 2. Description of the Related Art

For example, a wristwatch case is known which has a structure where an exterior component is attached to the outer circumferential surface of a case main body by screw parts, as described in Japanese Patent Application Laid-Open (Kokai) Publication No. 2023-039320. In that case, a push-button switch directed obliquely upward is provided on the six o'clock side of the case main body, and the exterior component is also attached to the six o'clock side of the case main body so as to protect the push-button switch.

### SUMMARY

An embodiment of the present disclosure is a case comprising: a case main body; a first exterior part which is arranged on an outer circumferential surface of the case main body; a second exterior part which is arranged on the outer circumferential surface of the case main body and an outer circumferential surface of the first exterior part; and an attachment part which attaches the second exterior part to the case main body, and attaches the first exterior part to the case main body by holding the first exterior part by the second exterior part.

Another embodiment of the present disclosure is a case manufacturing method for manufacturing a case including a case main body, a first exterior part which is arranged on an outer circumferential surface of the case main body, a second exterior part which is arranged on the outer circumferential surface of the case main body and an outer circumferential surface of the first exterior part, and an attachment part which attaches the second exterior part to the case main body, comprising: an arranging step of arranging the second exterior part on the outer circumferential surface of the first exterior part and the outer circumferential surface of the case main body with the first exterior part being arranged on the outer circumferential surface of the case main body; and a fixing step of fixing the first exterior part on the case main body by pressing the second exterior part against the outer circumferential surface of the first exterior part by the attachment part when attaching the second exterior part to the case main body by the attachment part.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is an enlarged perspective view showing an embodiment in which the present disclosure has been applied in a wristwatch;

FIG. 2 is an enlarged front view of the wristwatch of FIG. 1 when viewed from above;

FIG. 3 is an enlarged sectional view showing a main portion of the wristwatch of FIG. 1 taken along the III-III arrow view;

FIG. 4 is an enlarged sectional view showing the main portion of the wristwatch of FIG. 1 taken along the IV-IV arrow view;

FIG. 5A is an enlarged view showing the front side of a first exterior part of an exterior component on the six o'clock side of the wristwatch shown in FIG. 1;

FIG. 5B is an enlarged view showing the back side of the first exterior part;

FIG. 6A is an enlarged view showing the front side of a second exterior part of the exterior component on the six o'clock side of the wristwatch shown in FIG. 1; and

FIG. 6B is an enlarged view showing the back side of the second exterior part.

### DETAILED DESCRIPTION OF THE PREFERRED EMBODIMENTS

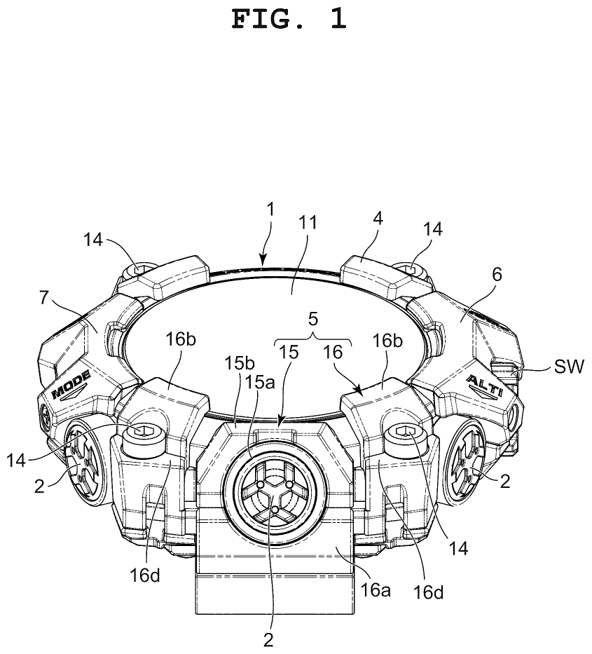

An embodiment where the present disclosure has been applied in a wristwatch will hereinafter be described with reference to FIG. 1 to FIG. 6B.

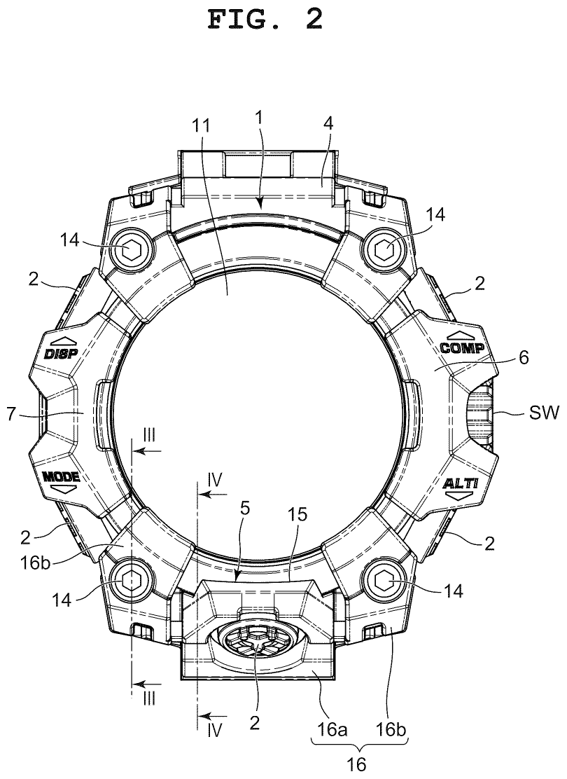

This wristwatch has a wristwatch case 1, as shown in FIG. 1 and FIG. 2. On the two o'clock side, four o'clock side, six o'clock side, eight o'clock side, and ten o'clock side of the wristwatch case 1, push-button switches 2 are provided, respectively.

Among these push-button switches 2, the push-button switch 2 on the six o'clock side is an upper surface switch directed obliquely upward, as shown in FIG. 1 and FIG. 2. The push-button switches 2 other than this upper surface switch are side surface switches directed sideward. Also, on the three o'clock side of the wristwatch case 1, a switch device SW such as a winder switch is provided.

The wristwatch case 1 includes a case main body 3 and a plurality of exterior components 4 to 7, as shown in FIG. 1 to FIG. 4. The case main body 3 includes a first case 8 and a second case 9. The first case 8 is made of a fiber-reinforced resin which is highly rigid and acquired by carbon fibers or glass fibers being mixed into a hard resin such as polyamide resin or epoxy resin, and has a substantially cylindrical shape. The second case 9 is made of a highly rigid metal such as stainless steel or titanium alloy, and is arranged on the upper surface of the first case 8 via a waterproof ring 10 which is a waterproofing part.

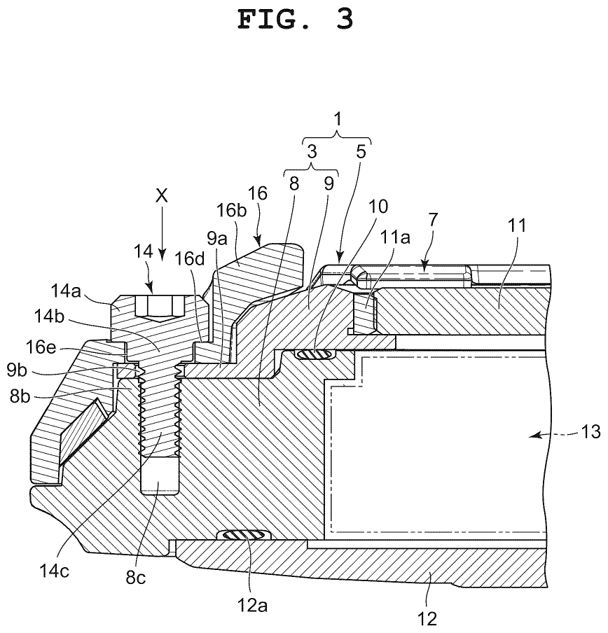

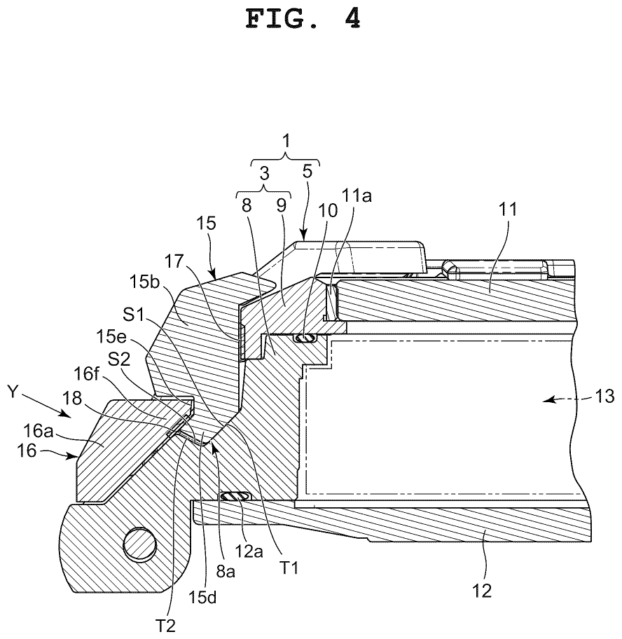

To the second case 9 which forms the upper opening of the case main body 3, a watch glass 11 is attached via a glass packing 11a, as shown in FIG. 3 and FIG. 4. Also, to the lower part of the first case 8 on the lower side of the case main body 3, a back cover 12 is attached via a waterproof packing 12a. Moreover, in the case main body 3, that is, in the first case 8, a timepiece module 13 is provided.

Although not shown in the drawings, this timepiece module 13 includes various types of components required for timepiece functions, such as a timepiece movement which moves pointers to indicate the time, a display device which electro-optically displays information such as a time of day, a date, and a day of the week, a circuit section which electrically drives and controls these components.

On the other hand, among the plurality of exterior components 4 to 7, the exterior component 4 is provided on the twelve o'clock side of the case main body 3, and another exterior component 5 is provided on the six o'clock side of the case main body 3, as shown in FIG. 1 and FIG. 2. Also, still another exterior component 6 is provided on the three o'clock side of the case main body 3, and yet another exterior component 7 is provided on the nine o'clock side of the case main body 3. These exterior components 4 to 7 are made of a high strength metal whose rigidity is high, such as stainless steel or titanium alloy.

Also, among the plurality of exterior components 4 to 7, the exterior components 4 and 5 on the twelve o'clock side and the six o'clock side are attached to the case main body 3 from above by screw parts 14 which are attachment parts described later, as shown in FIG. 1 to FIG. 3. In addition, the exterior components 6 and 7 on the three o'clock side and the nine o'clock side are attached to the case main body 3 from the sides by screws (not shown in the drawings).

The exterior component 5 on the six o'clock side among the plurality of exterior components 4 to 7 includes a first exterior part 15 which arranged is on the outer circumferential surface of the case main body 3, and a second exterior part 16 which is arranged on the outer circumferential surface of the case main body 3 and the outer circumferential surface of the first exterior part 15, as shown in FIG. 1, FIG. 2, and FIG. 4. The first exterior part 15 and the second exterior part 16 are separate parts, and individually subjected to surface treatment such as surface finish and painting.

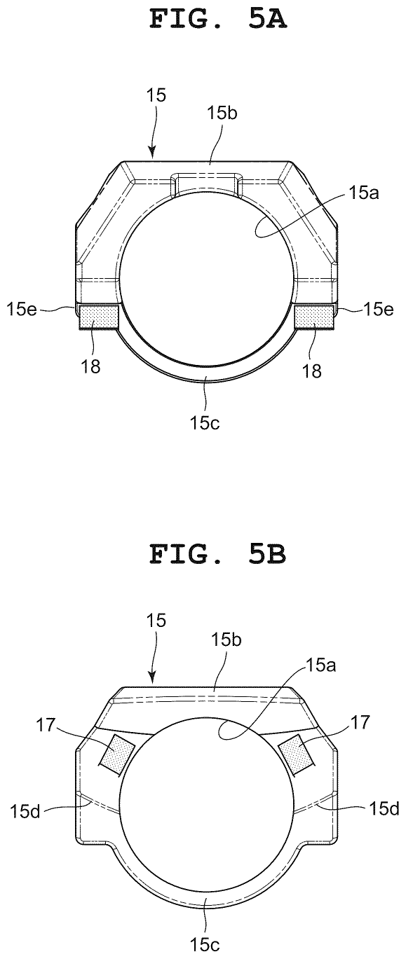

The first exterior part 15 is a switch protection part having an insertion hole 15a into which the switch head portion of the push-button switch 2 which is the upper surface switch provided on the six o'clock side of the case main body 3 is inserted such that switch operations can be performed thereon, as shown in FIG. 4, FIG. 5A, and FIG. 5B. More specifically, the first exterior part 15 includes a switch protection section 15b corresponding to a substantially upper half of the switch head portion of the push-button switch 2 on the six o'clock side, and a protection connection section 15c corresponding to a substantially lower half of the switch head portion of the push-button switch 2.

The switch protection section 15b is arranged extending from the upper surface of the second case 9 on the upper side of the case main body 3 to the outer circumferential surface of the upper part of the first case 8 through the outer circumferential surface of the second case 9, as shown in FIG. 4, FIG. 5A, and FIG. 5B. The protection connection section 15c has a semicircular belt-like shape thinner than the switch protection section 15b. On the surface (outer surface) of the protection connection section 15c, the second exterior part 16 is arranged so as to cover this protection connection section 15c.

On the undersurfaces of the side portions of the switch protection section 15b, contact sections 15d are formed which come in contact with a first stepped section 8a formed in the first case 8, as shown in FIG. 4. This first stepped section 8a of the first case 8 is an inclined shallow recess having a substantially V shape, and includes a first inclined surface S1 which gradually becomes lower toward the outer circumference side of the first case 8, and a second inclined surface S2 which gradually becomes higher toward the outer circumference side of the first case 8.

Each contact section 15d of the switch protection section 15b includes a first contact surface T1 which comes in contact with the first inclined surface S1 of the first stepped section 8a of the first case 8, and a second contact surface T2 which comes in contact with the second inclined surface S2 of the first stepped section 8a of the first case 8, as shown in FIG. 4. On the lower sides of the side portions of the front surface (outer surface) of the switch protection section 15b, recess sections 15e are formed to be positioned one step lower, respectively. To these recess sections 15e, the upper sides of the side portions of the protection connection section 15c are connected.

Also, the first exterior part 15 is provided with first buffering parts 17 and second buffering parts 18, as shown in FIG. 4, FIG. 5A, and FIG. 5B. The first buffering parts 17 and the second buffering parts 18 are made of an elastic material such as silicone rubber, and provided with an adhesive having an adhesive property. The first buffering parts 17, which are positioned between the second case 9 of the case main body 3 and the first exterior part 15, adhere to side portions of the upper side of the back surface (inner surface) of the switch protection section 15b of the first exterior part 15, as shown in FIG. 5B.

The second buffering parts 18 are positioned between the first exterior part 15, the first case 8, and the second exterior part 16, as shown in FIG. 4 and FIG. 5A. These second buffering parts 18 adhere to the recess sections 15e formed one step lower on the lower end portions of the side parts of the front surface (outer surface) of the switch protection section 15b of the first exterior part 15, as shown in FIG. 5A.

That is, the second buffering parts 18 are provided extending from the recess sections 15e formed on the lower portions of the side parts of the switch protection section 15b of the first exterior part 15 to the front surface (outer surface) of the first case 8 such that pressing sections 16f formed on the upper sides of the side portions of a later-described guide hold-down section 16a of the second exterior part 16 are pressed against these second buffering parts 18, as shown in FIG. 4 and FIG. 5A. Accordingly, the first buffering parts 17 are provided to be positioned upwardly away from the second buffering parts 18, on the back surface (inner surface) of the switch protection section 15b of the first exterior part 15.

More specifically, for example, the first buffering parts 17 may be arranged on surfaces farthest from the second buffering parts 18 among the surfaces of the first exterior part 15 opposing the side surface of the case main body 3, as shown in FIG. 4. Also, for example, the first buffering parts 17 may be arranged at positions shifted toward the upper side of the case main body 3, that is, the visible side of the wristwatch, on the above-described opposing surface of the first exterior part 15 so as to avoid areas at the same height as the surfaces of the recess sections 15e of the first exterior part 15 where the pressing sections 16f of the second exterior part 16 approach or come in contact, as shown in FIG. 4.

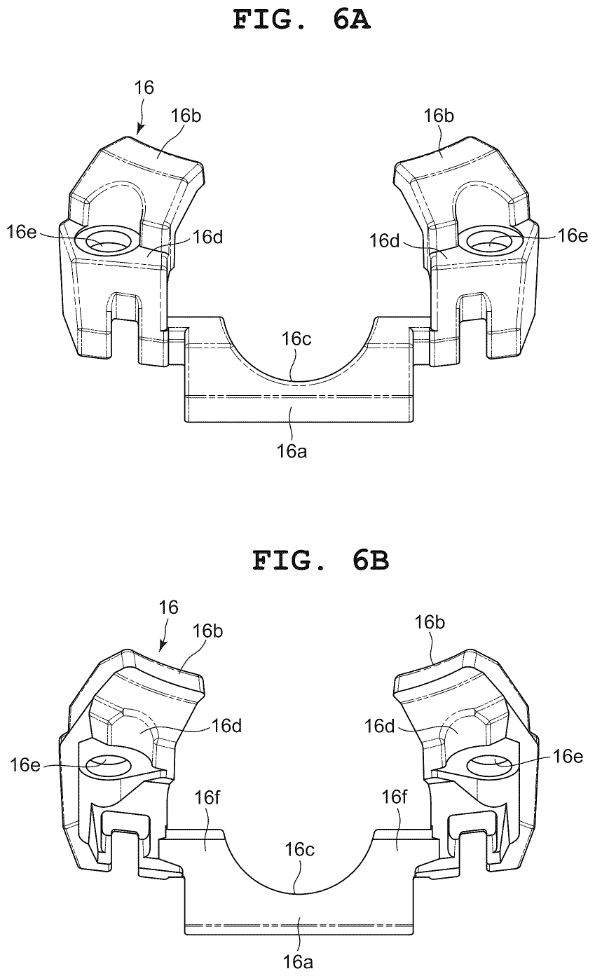

On the other hand, the second exterior part 16 includes the guide hold-down section 16a which guides the switch head portion of the push-button switch 2 on the six o'clock side such that switch operations can be performed thereon, and holds down the switch protection section 15b of the first exterior part 15 on the case main body 3, and a pair of hold-down attachment sections 16b which are located to the sides of the switch protection section 15b of the first exterior part 15 in the outer circumferential directions of the case main body 3, and attached to the case main body 3 by the screw parts 14 which are attachment parts, as shown in FIG. 4, FIG. 6A, and FIG. 6B.

The guide hold-down section 16a is integrally formed between the pair of hold-down attachment sections 16b and positioned on the lower half of the switch head portion of the push-button switch 2 on the six o'clock side, as shown in FIG. 4, FIG. 6A, and FIG. 6B. This guide hold-down section 16a includes the pressing sections 16f which press the recess sections 15e on the lower portions of the side parts of the switch protection section 15b of the first exterior part 15 and the second buffering parts 18 against the case main body 3. These pressing sections 16f are formed on the side portions of the upper part of the guide hold-down section 16a.

Also, the guide hold-down section 16a is located such that its upper edge part is positioned on the lower half of the switch head portion of the push-button switch 2 on the six o'clock side, and its lower edge part is positioned on the lower part of the first case 8 of the case main body 3, as shown in FIG. 1, FIG. 4, FIG. 6A, and FIG. 6B. On the upper edge part of the guide hold-down section 16a, a cutout section 16c having a semicircular shape is formed. This cutout section 16c having a semicircular shape guides the lower half of the switch head portion of the push-button switch 2 on the six o'clock side such that switch operations can be performed thereon.

In the case of this guide hold-down section 16a, in a state where the back surface (inner surface) of the edge portion of the semicircular cutout section 16c has covered the protection connection section 15c of the first exterior part 15, the pressing sections 16f located to the sides of the cutout section 16c hold down the recess sections 15e on the lower portions of the side parts of the switch protection section 15b of the first exterior part 15 and the second buffering parts 18 against the case main body 3, as shown in FIG. 4, FIG. 6A, and FIG. 6B.

The pair of hold-down attachment sections 16b are arranged extending from the upper surface of the second case 9 on the upper side of the case main body 3 to the outer circumferential surface of the lower part of the first case 8 corresponding to the lower part of the switch protection section 15b of the first exterior part 15 through the outer circumferential surface of the second case 9 while being positioned to the sides of the switch protection section 15b of the first exterior part 15, as shown in FIG. 1, FIG. 4, FIG. 6A, and FIG. 6B.

On the other hand, on upper portions of the first case 8 corresponding to the pair of hold-down attachment sections 16b, a flat section 8b is formed, as shown in FIG. 3. On the second case 9, an attachment projection section 9a which is arranged on this flat section 8b of the first case 8 is formed. Also, on the pair of hold-down attachment sections 16b, screw attachment sections 16d which are arranged on the attachment projection section 9a of the second case 9 are formed, as shown in FIG. 3, FIG. 6A, and FIG. 6B. These hold-down attachment sections 16b are attached with the screw attachment sections 16d holding down the second case 9 on the first case 8 by the screw parts 14 which are attachment parts.

Each screw part 14 includes a head section 14a, a neck lower section 14b, and a thread section 14c in the order from its one end to the other end. As for their outer diameters, the outer diameter of the head section 14a is the longest, the outer diameter of the neck lower section 14b is the second longest, and the outer diameter of the thread section 14c is the shortest, as shown in FIG. 3. The head section 14a of this screw part 14 is arranged on the screw attachment section 16d of the corresponding hold-down attachment section 16b. As to the neck lower section 14b, its lower end surface is pressed against the upper surface of the attachment projection section 9a of the second case 9 through a first screw insertion hole 16e in the screw attachment section 16d. The thread section 14c is screwed into a corresponding screw hole 8c formed in the flat section 8b of the first case 8 through a corresponding second screw insertion hole 9b in the attachment projection section 9a of the second case 9.

As a result of the structure of this screw part 14, when the thread section 14c is screwed into the screw hole 8c of the first case 8 and fastened, the lower end surface of the neck lower section 14b presses the attachment projection section 9a of the second case 9 against the flat section 8b of the first case 8, and the lower end surface of the head section 14a presses the screw attachment section 16d of the second exterior part 16 against the attachment projection section 9a of the second case 9, as shown in FIG. 3.

Also, this screw part 14 is structured such that, when the neck lower section 14b presses the attachment projection section 9a of the second case 9 against the flat section 8b of the first case 8, the second case 9 is pressed against the first case 8, whereby the waterproof ring 10 arranged between the first case 8 and the second case 9 is compressed so as to achieve waterproofing between the first case 8 and the second case 9 and ensure the airtightness, as shown in FIG. 3.

Moreover, this screw part 14 is structured such that, when the lower end surface of the head section 14a presses the screw attachment section 16d of the second exterior part 16 against the attachment projection section 9a of the second case 9, the corresponding one of the pressing sections 16f located at the side portions of the upper part of the guide hold-down section 16a of the second exterior part 16, that is, the corresponding one of the pressing sections 16f located to the sides of the cutout section 16c of the guide hold-down section 16a presses the corresponding one of the recess sections 15e on the lower portions of the side parts of the switch protection section 15b of the first exterior part 15 and the corresponding second buffering part 18 against the case main body 3, as shown in FIG. 3.

When the recess sections 15e on the lower portions of the side parts of the switch protection section 15b are pressed against the case main body 3 via the second buffering parts 18 by the pressing sections 16f of the guide hold-down section 16a of the second exterior part 16, the first exterior part 15 is pressed against and fixed on the outer circumferential surface of the case main body 3 via the first buffering parts 17 attached to the back surface of the switch protection section 15b, as shown in FIG. 4.

As to the second exterior part 16, the hold-down direction (arrow direction Y in FIG. 4) in which the guide hold-down section 16a holds down the switch protection section 15b of the first exterior part 15 when the second exterior part 16 is attached to the case main body 3 by the screw parts 14 and the fastening direction (arrow direction X in FIG. 3) of each screw part 14 which is an attachment direction in which each screw part 14 attaches the corresponding screw attachment section 16d of the second exterior part 16 to the case main body 3 are different from each other, as shown in FIG. 3 and FIG. 4. That is, the hold-down direction (arrow direction Y) of each pressing section 16f of the guide hold-down section 16a of the second exterior part 16 intersects with the fastening direction (arrow direction X) of each screw part 14.

Also, when the recess sections 15e on the lower portions of the side parts of the switch protection section 15b are pressed against the case main body 3 via the second buffering parts 18 by the pressing sections 16f at the side portions of the upper part of the guide hold-down section 16a of the second exterior part 16, the first exterior part 15 comes in contact with and is fixed on three areas, which are the outer circumferential surface of the case main body 3, the first buffering parts 17 of the switch protection section 15b, and portions of the outer circumferential surface of the case main body 3 corresponding to the second buffering parts 18, as shown in FIG. 4. As a result, by the first buffering parts 17 and the second buffering parts 18, the first exterior part 15 is fixed to the case main body 3 without rattling.

Also, when the first exterior part 15 is held down on the case main body 3 by the second exterior part 16 via the second buffering parts 18, the first contact surfaces T1 of the contact sections 15d formed on the undersurfaces of the side portions of the switch protection section 15b come in contact with the first inclined surface S1 of the first stepped section 8a of the first case 8, as shown in FIG. 4. Here, the first exterior part 15 is fixed to the case main body 3 by the first buffering parts 17 attached to the side portions of the upper side of the back surface of the switch protection section 15b being pressed against the outer circumferential surface of the second case 9 of the case main body 3 with the second contact surfaces T2 of the contact sections 15d opposing the second inclined surface S2 of the first stepped section 8a.

That is, in the case of this first exterior part 15, the first contact surfaces T1 of the contact sections 15d formed on the undersurfaces of the side portions of the switch protection section 15b are positioned between the first buffering parts 17 and the second buffering parts 18, as shown in FIG. 4. Accordingly, the contact sections 15d of the switch protection section 15b resiliently come in contact with the first inclined surface S1 of the first stepped section 8a of the first case 8 against the buffering force (elastic force) of the first buffering parts 17 and that of the second buffering parts 18, whereby the first exterior part 15 is fixed to the case main body 3 without rattling.

Note that the exterior component 4 on the twelve o'clock side has the same structure as the second exterior part 16 of the exterior component 5 on the six o'clock side, as shown in FIG. 1 and FIG. 2. That is, the exterior component 4 on the twelve o'clock side is structured such that, when the second case 9 is pressed against the first case 8 by the screw parts 14, the waterproof ring 10 arranged between the first case 8 and the second case 9 is compressed, whereby waterproofing between the first case 8 and the second case 9 is achieved and the airtightness is ensured.

Next, a method for manufacturing this wristwatch case 1 is described.

This manufacturing method includes an arranging step where the second exterior part 16 is arranged on the outer circumferential surface of the case main body 3 and the outer circumferential surface of the first exterior part 15 with the first exterior part 15 being arranged on the outer circumferential surface of the case main body 3, and a fixing step where the second exterior part 16 presses the first exterior part 15 against the case main body 3 by the screw parts 14 so as to fix the first exterior part 15, as shown in FIG. 3 and FIG. 4.

More specifically, in the arranging the first exterior part 15 is first arranged on the outer circumferential surface of the case main body 3 with the first buffering parts 17 being interposed between the case main body 3 and the first exterior part 15. Next, the second exterior part 16 is arranged on the outer circumferential surface of the first exterior part 15 and the outer circumferential surface of the case main body 3 with the second buffering parts 18 being interposed between the first exterior part 15 and the second exterior part 16. Here, before this arrangement, the first exterior part 15 and the second exterior part 16 are individually subjected to surface treatment such as surface finishing and painting.

This arranging step may include a step of providing the first buffering parts 17 on the surface of the first exterior part 15 opposing the second case 9, as shown in FIG. 5B. Also, this arranging step may include a step of arranging the first exterior part 15 on the outer circumferential surface of the case main body 3 and then providing the first buffering parts 17 in a manner to extend from the recess sections 15e of the first exterior part 15 shown in FIG. 5A toward the front surface (outer surface) of the first case 8.

In the fixing step, when the second exterior part 16 is to be attached to the case main body 3 by the screw parts 14, the second exterior part 16 holds down the first exterior part 15 and the second buffering parts 18 on the case main body 3 in the direction (arrow direction Y in FIG. 4) intersecting with the fastening direction (arrow direction X in FIG. 3) of each screw part 14, whereby the second exterior part 16 presses the first exterior part 15 and the first buffering parts 17 against the case main body 3 so as to fix them.

That is, in this fixing step, when the second exterior part 16 is to be attached to the case main body 3 by the screw parts 14, the second case 9 is pressed against the first case 8 by the second exterior part 16, and the airtightness between the first case 8 and the second case 9 is maintained by the waterproof ring 10. Then, in this state, the first exterior part 15 is forced toward the case main body 3 side by the second exterior part 16 via the second buffering parts 18.

Also, in this fixing step, by the first exterior part 15 being forced toward the case main body 3 side by the second exterior part 16 via the second buffering parts 18 when the second exterior part 16 is attached to the case main body 3 by the screw parts 14, the second exterior part 16 is fixed on the case main body 3 by the screw parts 14 such that the first exterior part 15 is fixed on the case main body 3. As a result, by the first buffering parts 17 and the second buffering parts 18, the first exterior part 15 is fixed on the case main body 3 without rattling.

Moreover, when the second exterior part 16 is to be attached to the case main body 3 by the screw parts 14, the thread sections 14c of the screw parts 14 are screwed into the screw holes 8c in the flat section 8b of the first case 8 from the first screw insertion holes 16e in the screw attachment sections 16d of the hold-down attachment sections 16b of the second exterior part 16 through the second screw insertion holes 9b of the attachment projection section 9a of the second case 9, and tightened therein.

Here, the neck lower sections 14b of the screw parts 14 are inserted into the first screw insertion holes 16e in the screw attachment sections 16d of the hold-down attachment sections 16b of the second exterior part 16, and the lower end surfaces of the neck lower sections 14b are pressed against the upper surface of the attachment projection section 9a of the second case 9. Accordingly, the second case 9 is pressed against the first case 8, and the waterproof ring 10 between the first case 8 and the second case 9 is compressed. As a result, the second case 9 is attached to the first case 8 and the airtightness between the first case 8 and the second case 9 is maintained by the waterproof ring 10.

Also, here, the lower end surfaces of the head sections 14a of the screw parts 14 press the screw attachment sections 16d of the second exterior part 16 against the attachment projection section 9a of the second case 9, and the second exterior part 16 presses the first exterior part 15 toward the case main body 3 side. Here, the pressing direction (arrow direction Y in FIG. 4) in which the second exterior part 16 presses the first exterior part 15 intersects with the fastening direction (arrow direction X in FIG. 3) of each screw part 14.

Although the pressing direction (arrow direction Y) in which the second exterior part 16 presses the first exterior part 15 intersects with the fastening direction (arrow direction X) of each screw part 14, the second exterior part 16 holds down the first exterior part 15 and the second buffering parts 18 on the case main body 3. As a result, the second exterior part 16 presses the first exterior part 15 and the first buffering parts 17 against the case main body 3, whereby the first exterior part 15 is fixed on the case main body 3 without rattling.

For example, in the case of the above-described exterior component of the wristwatch case disclosed in Japanese Patent Application Laid-Open (Kokai) Publication No. 2023-039320, a switch protection section provided with an insertion hole into which the push-button switch is inserted such that switch operations can be performed thereon and a protection attachment section which attaches this switch protection section to the case main body are integrally formed. In this type of wristwatch case, if the shape of the exterior component which is exposed to the outside of the case main body is complicated, desired surface treatment such as surface finishing is difficult to be performed on an intended portion of the exterior component. That is, this type of wristwatch case has restrictions regarding the design.

In contrast, the wristwatch case 1 of the present disclosure includes the case main body 3, the first exterior part 15 which is arranged on the outer circumferential surface of the case main body 3, the second exterior part 16 which is arranged on the outer circumferential surface of the case main body 3 and the outer circumferential surface of the first exterior part 15, and each screw part 14 which is an attachment part that attaches the second exterior part 16 to the case main body 3, and attaches the first exterior part 15 to the case main body 3 by holding the first exterior part 15 by the second exterior part 16. As a result of this structure, the above-described design restrictions are reduced.

That is, if the first exterior part 15 and the second exterior part 16 have been integrally formed to be one exterior component, some portions are difficult to be subjected to surface treatment. However, the wristwatch case 1 of the present disclosure is different from that case, and the first exterior part 15 and the second exterior part 16 are different parts. Accordingly, intended surface treatment can be performed on desired portions of the first exterior part 15 or the second exterior part 16 before they are attached to each other, and then these first and second exterior parts 15 and 16 can be attached to each other to form one exterior component. As a result of this structure, exterior components 5 can be achieved which have various shapes when the first exterior part 15 and the second exterior part 16 are mounted on the case main body 3. That is, the design restrictions can be reduced.

Also, for example, if the above-described one exterior component where the first exterior part 15 and the second exterior part 16 have been integrally formed is made of resin, two-color molding is required to be performed when the surface of a portion corresponding to the first exterior part 15 and the surface of a portion corresponding to the second exterior part 16 among all the surfaces of the one exterior component are desired to be differently colored. However, if two-color molding cannot be performed for some reason, an intended design cannot be achieved. Here, if the first exterior part 15 and the second exterior parts 16 are different parts as the present disclosure, it is only required that the resin parts colored in desired colors are attached to each other, which also reduces the design restrictions.

Moreover, for example, if the above-described one exterior component where the first exterior part 15 and the second exterior part 16 have been integrally formed is made of metal, and the surface of one part includes two surfaces which are adjacent to each other at an angle in a cross-sectional view, hairline finishing cannot be performed on one of the two adjacent surfaces when the angle (the angle on the outer portion side of the exterior component) between the two surfaces is an acute angle. However, if the first exterior part 15 and the second exterior parts 16 are different parts as the present disclosure, it is only required that hairline finishing is performed on intended surfaces before the first exterior part 15 and the second exterior part 16 are attached to each other, and then the first exterior part 15 and the second exterior part 16 are attached, which also reduces the design restrictions.

Also, this wristwatch case 1 includes the first buffering parts 17 which are interposed between the first exterior part 15 and the case main body 3, and the second buffering parts 18 which are interposed between the first exterior part 15 and the second exterior part 16. Accordingly, when the second exterior part 16 presses the outer circumferential surface of the first exterior part 15 so as to fix the first exterior part 15 on the case main body 3 by the screw parts 14, the first exterior part 15 is fixed to the case main body 3 without rattling, by the buffering force (elastic force) of the first buffering parts 17 and that of the second buffering parts 18.

Moreover, in the case of this wristwatch case 1, the first buffering parts 17 and the second buffering parts 18 are provided with an adhesive having an adhesive property. Accordingly, the first buffering parts 17 can be attached to the back surface (inner surface) of the first exterior part 15, and the second buffering parts 18 can be attached to the front surface (outer surface) of the first exterior part 15. As a result of this structure, the first buffering parts 17 and the second buffering parts 18 can be easily and favorably attached to the first exterior part 15 before the first exterior part 15 is arranged on the outer circumferential surface of the case main body 3, whereby the arrangement of the first exterior part 15 and the second exterior part 16 on the case main body 3 can be easily performed.

Furthermore, in the case of this wristwatch case 1, the screw parts 14 are provided to press the second exterior part 16 against the outer circumferential surface of the first exterior part 15, the second buffering parts 18 are arranged on the areas where the second exterior part 16 presses the first exterior part 15 against the case main body 3, and the first buffering parts 17 are arranged on the surfaces farthest from the second buffering parts 18 among the surfaces of the first exterior part 15 opposing the side surface of the case main body 3. Accordingly, when the second exterior part 16 presses the first exterior part 15 and the second buffering parts 18 against the case main body 3, the first exterior part 15 is reliably and favorably fixed on the case main body 3 without rattling by the second buffering parts 18 and the first buffering parts 17.

More specifically, although the first buffering parts 17 may be provided on positions slightly shifted downward on the back surface of the first exterior part 15, that is, positions slightly shifted toward each second buffering part 18 side, these first buffering parts 17 should preferably be provided to be away from the second buffering parts 18 as much as possible as with the wristwatch case 1 of the present disclosure so that the rattling of the first exterior part 15 with respect to the case main body 3 can be further reduced.

Also, in the case of this wristwatch case 1, the screw parts 14 are provided to press the second exterior part 16 against the outer circumferential surface of the first exterior part 15, and the first exterior part 15 is pressed against and fixed on the outer circumferential surface of the case main body 3 and the first buffering part 17 when pressed against the outer circumferential surface of the case main body 3 by the second exterior part 16 via the second buffering parts 18. As a result of this structure, the first exterior part 15 can be reliably and favorably fixed on the case main body 3 by three-point mounting.

Moreover, in the case of this wristwatch case 1, the contact sections 15d of the first exterior part 15 which come in contact with the outer circumferential surface of the case main body 3 are formed between the first buffering parts 17 and the second buffering parts 18. Accordingly, the contact sections 15d of the first exterior part 15 resiliently come in contact with the outer circumferential surface of the case main body 3 against the buffering force (elastic force) of the first buffering parts 17 and that of the second buffering parts 18, whereby the first exterior part 15 is reliably and favorably fixed on the case main body 3 without rattling.

Furthermore, in the case of this wristwatch case 1, when held down on the case main body 3 by the second exterior part 16, the first exterior part 15 can be elastically and favorably fixed on the outer circumferential surface of the second case 9 of the case main body 3 by the first buffering parts 17 attached to the side portions of the upper side of the back surface of the switch protection section 15b with the first contact surfaces T1 of the contact sections 15d on the undersurfaces of the side portions of the switch protection section 15b of the first exterior part 15 being in contact with the first inclined surface S1 of the first stepped section 8a of the first case 8 and the second contact surfaces T2 of the contact sections 15d opposing the second inclined surface S2 of the first stepped section 8a of the first case 8.

Still further, in the case of this wristwatch case 1, since the screw parts 14 are provided to press the second exterior part 16 against the outer circumferential surface of the first exterior part 15, and the hold-down direction (arrow direction Y in FIG. 4) in which the second exterior part 16 holds down the first exterior part 15 and the fastening direction (arrow direction X in FIG. 3) of each screw part 14 which is the attachment direction in which each screw part 14 attaches the second exterior part 16 to the case main body 3 are different from each other such that the hold-down direction (arrow direction Y) of the second exterior part 16 intersects with the fastening direction (arrow direction X) of each screw part 14, the waterproofness of the case main body 3 is ensured and the first exterior part 15 is reliably fixed on the case main body 3 by the second exterior part 16.

Yet still further, in the case of this wristwatch case 1, the case main body 3 includes the first case 8 and the second case 9 which is arranged on the upper surface side of the first case 8, the waterproof ring 10 which is a waterproofing part is interposed between the first case 8 and the second case 9, and the screw parts 14 are provided to maintain the airtightness between the first case 8 and the second case 9 by the waterproofing part by pressing the second exterior part 16 against the outer circumferential surface of the first exterior part 15 and compressing the waterproof ring 10. As a result of this structure, when the second case 9 is pressed against the first case 8, the waterproof ring 10 is compressed between the first case 8 and the second case 9, whereby the waterproofness and airtightness between the first case 8 and the second case 9 are ensured.

Yet still further, in the case of this wristwatch case 1, each screw part 14 includes the head section 14a, the neck lower section 14b, and the thread section 14c, and the thread sections 14c are screwed into the screw holes 8c of the first case 8 through the second screw insertion holes 9b of the second case 9 and tightened therein with the neck lower sections 14b being pressed against the second case 9 through the first screw insertion holes 16e of the second exterior part 16. As a result, the second case 9 is pressed against the first case 8, whereby the airtightness between the first case 8 and the second case 9 is ensured by the waterproof ring 10. In addition, the second exterior part 16 presses the first exterior part 15 against the case main body 3, whereby the first exterior part 15 is reliably fixed on the case main body 3.

Yet still further, in the case of this wristwatch case 1, the first exterior part 15 and the second exterior part 16 protect the switch head portion of the push-button switch 2 which is the upper surface switch provided on the six o'clock side of the case main body 3 such that switch operations can be performed thereon. As a result of this structure, the switch head portion of the push-button switch 2 can be favorably protected by the first exterior part 15 and the second exterior part 16 so as not to be subjected to external impacts and damaged, and switch operations can be favorably performed on the switch head portion of the push-button switch 2.

Also, the manufacturing method for this wristwatch case 1 includes the arranging step at which the first exterior part 15 is arranged on the outer circumferential surface of the case main body 3 with the first buffering parts 17 being interposed between the case main body 3 and the first exterior part 15 and, in this state, the second exterior part 16 is arranged on the outer circumferential surface of the first exterior part 15 and the outer circumferential surface of the case main body 3 with the second buffering parts 18 being interposed between the first exterior part 15 and the second exterior part 16, and the fixing step at which, when the second exterior part 16 is to be attached to the case main body 3 by the screw parts 14 that are attachment parts, the second exterior part 16 holds down the first exterior part 15 and the second buffering parts 18 in the direction intersecting with the fastening direction which is the attachment direction in which each screw part 14 attaches the second exterior part 16 to the case main body 3, and presses the first exterior part 15 and the first buffering parts 17 against the case main body 3 so as to fix them. As a result of this method, surface treatment on the first exterior part 15 and the second exterior part 16 can be easily performed, which enhances the design. In addition, the first exterior part 15 and the second exterior part 16 can be reliably and favorably fixed on the case main body 3.

That is, in the manufacturing method for this wristwatch case 1, the first exterior part 15 and the second exterior part 16 are individually manufactured in advance. Then, in the arranging step, the first exterior part 15 and the second exterior part 16, which are separate parts, are arranged on the outer circumferential surface of the case main body 3. By this method, the first exterior part 15 and the second exterior part 16 do not have complicated shapes, whereby surface treatment such as surface finishing and painting for the first exterior part 15 and the second exterior part 16 can be easily and beautifully performed, which enhances the design. In addition, the first exterior part 15 and the second exterior part 16 can be accurately and favorably arranged on the case main body 3.

Also, in the fixing step in the manufacturing method for this wristwatch case 1, when the second exterior part 16 is to be attached to the case main body 3 by the screw parts 14, the second exterior part 16 holds down the first exterior part 15 and the second buffering parts 18 in the direction (arrow direction Y in FIG. 4) intersecting with the fastening direction (arrow direction X in FIG. 3) which is the attachment direction in which each screw part 14 attaches the second exterior part 16 to the case main body 3. As a result, the second exterior part 16 presses the first exterior part 15 against the case main body 3 together with the first buffering parts 17, whereby the first exterior part 15 is reliably and favorably fixed on the case main body 3 without rattling.

Moreover, in the fixing step in the manufacturing method for this wristwatch case 1, when the second exterior part 16 is to be attached to the case main body 3 by the screw parts 14, the second case 9 is pressed against the first case 8, whereby the airtightness between the first case 8 and the second case 9 can be ensured by the waterproof ring 10, and the first exterior part 15 can be held down on the case main body 3 by the second exterior part 16 together with the second buffering parts 18.

Furthermore, in the fixing step in the manufacturing method for this wristwatch case 1, when the second exterior part 16 is to be attached to the case main body 3 by the screw parts 14, the first exterior part 15 is forced toward the case main body 3 side by the second exterior part 16 via the first buffering parts 17. As a result of this method, the second exterior part 16 is fixed on the case main body 3 by the screw parts 14 such that the first exterior part 15 is fixed on the case main body 3. Accordingly, the first exterior part 15 is reliably and favorably fixed on the case main body 3 by the second exterior part 16.

In the above-described embodiment, the push-button switch 2 which is the upper surface switch provided on the six o' clock side of the case main body 3 is protected by the first exterior part 15 and the second exterior part 16. However, the present disclosure is not limited thereto. For example, a structure may be adopted in which the plurality of push-button switches 2 that are the side surface switches provided on the two o'clock side, four o'clock side, eight o'clock side, and ten o'clock side of the wristwatch case 1, and the switch device SW such as a winder switch provided on the three o'clock side are protected by the first exterior part 15 and the second exterior part 16.

Also, in the above-described embodiment, the present disclosure has been applied in a wristwatch. However, the present disclosure is not necessarily required to be applied in a wristwatch. For example, the present disclosure is applicable to various types of timepieces such as a travel watch, an alarm clock, a table clock, and a wall clock. In addition, the present disclosure is not necessarily required to be applied in timepieces, and can be applied in electronic devices cell-phones and portable information terminals.

While the present invention has been described with reference to the preferred embodiments, it is intended that the invention be not limited by any of the details of the description therein but includes all the embodiments which fall within the scope of the appended claims.

What is claimed is:

1. A case comprising:
a case main body;
a first exterior part which is arranged on an outer circumferential surface of the case main body;
a second exterior part which is arranged on the outer circumferential surface of the case main body and an outer circumferential surface of the first exterior part; and
an attachment part which attaches the second exterior part to the case main body, and attaches the first exterior part to the case main body by holding the first exterior part by the second exterior part.

2. The case according to claim 1, further comprising:
a first buffering part which is interposed between the first exterior part and the case main body; and
a second buffering part which is interposed between the first exterior part and the second exterior part.

3. The case according to claim 2, wherein the first exterior part and the second exterior part are made of a metal whose rigidity and strength are high.

4. The case according to claim 2, wherein the attachment part is provided to press the second exterior part against the outer circumferential surface of the first exterior part,
wherein the second buffering part is arranged on an area where the second exterior part presses the first exterior part against the case main body, and
wherein the first buffering part is arranged on a surface farthest from the second buffering part among surfaces of the first exterior part opposing a side surface of the case main body.

5. The case according to claim 2, wherein the attachment part is provided to press the second exterior part against the outer circumferential surface of the first exterior part, and
wherein the first exterior part is pressed against and fixed on the outer circumferential surface of the case main body and the first buffering part when pressed against the outer circumferential surface of the case main body by the second exterior part 16 via the second buffering part.

6. The case according to claim 5, wherein the first exterior part has a contact section which is provided between the first buffering part and the second buffering part and comes in contact with the outer circumferential surface of the case main body.

7. The case according to claim 1, wherein the attachment part is provided to press the second exterior part against the outer circumferential surface of the first exterior part, and
wherein a hold-down direction in which the second exterior part holds down the first exterior part intersects with an attachment direction in which the attachment part attaches the second exterior part to the case main body.

8. The case according to claim 1, wherein the case main body includes a first case and a second case which is arranged on an upper surface side of the first case,
wherein a waterproofing part is interposed between the first case and the second case, and
wherein the attachment part is provided to maintain airtightness between the first case and the second case by the waterproofing part by pressing the second exterior part against the outer circumferential surface of the first exterior part and compressing the waterproof part.

9. The case according to claim 1, wherein the first exterior part and the second exterior part protect a push-button provided on the case main body such that a button operation is performable.

10. A timepiece comprising the case according to claim 1.

11. A timepiece comprising the case according to claim 2.

12. A timepiece comprising the case according to claim 3.

13. A timepiece comprising the case according to claim 4.

14. A timepiece comprising the case according to claim 5.

15. A timepiece comprising the case according to claim 7.

16. A timepiece comprising the case according to claim 8.

17. A case manufacturing method for manufacturing a case including a case main body, a first exterior part which is arranged on an outer circumferential surface of the case main body, a second exterior part which is arranged on the outer circumferential surface of the case main body and an outer circumferential surface of the first exterior part, and an attachment part which attaches the second exterior part to the case main body, comprising:
an arranging step of arranging the second exterior part on the outer circumferential surface of the first exterior part and the outer circumferential surface of the case main body with the first exterior part being arranged on the outer circumferential surface of the case main body; and
a fixing step of fixing the first exterior part on the case main body by pressing the second exterior part against the outer circumferential surface of the first exterior part by the attachment part when attaching the second exterior part to the case main body by the attachment part.

18. The case manufacturing method according to claim 17, wherein the fixing step is a step at which, when the second exterior part is to be attached to the case main body by the attachment part, the second exterior part presses and fixes the first exterior part with respect to the case main body by holding down the first exterior part in a direction intersecting with an attachment direction in which the attachment part attaches the second exterior part to the case main body.

19. The case manufacturing method according to claim 17, wherein the case includes a first buffering part which is interposed between the case main body and the first exterior part, and a second buffering part which is interposed between the first exterior part and the second exterior part,
wherein the arranging step is a step at which the second exterior part is arranged on the outer circumferential surface of the first exterior part and the outer circumferential surface of the case main body via the second buffering part interposed between the first exterior part and the second exterior part, with the first exterior part being arranged on the outer circumferential surface of the case main body via the first buffering part interposed between the case main body and the first exterior part, and
wherein the fixing step is a step at which, when the second exterior part is to be attached to the case main body by the attachment part, the second exterior part presses and fixes the first exterior part and the first buffering part with respect to the case main body by holding down the first exterior part and the second buffering part in a direction intersecting with an attachment direction in which the attachment part attaches the second exterior part to the case main body.

20. The case manufacturing method according to claim 17, wherein the case includes a first case and a second case which is arranged on an upper surface side of the first case, and
wherein the fixing step is a step at which the attachment part is provided to maintain airtightness between the first case and the second case by a waterproofing part by pressing the second exterior part against the outer circumferential surface of the first exterior part with the waterproofing part being interposed between the first case and the second case, and compressing the waterproofing part.
